(19) United States
(12) Patent Application Publication
(10) Pub. No.: US 2022/0120568 A1
(43) Pub. Date: Apr. 21, 2022

(54) ELECTRONIC DEVICE FOR VEHICLE, AND METHOD OF OPERATING ELECTRONIC DEVICE FOR VEHICLE

(71) Applicant: LG Electronics Inc., Seoul (KR)

(72) Inventors: Seunghwan BANG, Seoul (KR); Sungmin KIM, Seoul (KR); Jeongeun SHIN, Seoul (KR)

(21) Appl. No.: 17/260,520

(22) PCT Filed: Jul. 3, 2019
(86) PCT No.: PCT/KR2019/008134

§ 371 Date: Jan. 14, 2021

(51) Int. Cl. G01C 21/32; G01C 21/00

(52) U.S. Cl. CPC G01C 21/32; G01C 21/3878; G01C 21/3833; G01C 21/3807

(57) ABSTRACT

An electronic device for a vehicle includes a power supply configured to supply power, an interface configured to receive high-definition (HD) map data of a specified region and to receive data of an object from an object detection device, and a processor configured to continuously acquire electronic horizon data of the specified region based on the HD map data in a state in which the power is received, to perform map matching based on the data of the object, and to perform map matching based on a second object set to new map matching feature when map matching based on a first object preset to map matching feature fails. Data generated by the electronic device for a vehicle is transmitted to an external device through a 5G communication method. The electronic device for a vehicle is embodied using an artificial intelligence (AI) algorithm. The data generated by the electronic device for a vehicle is embodied as augmented reality (AR) content.

### TECHNICAL FIELD

The present disclosure relates to an electronic device for a vehicle, and a method of operating an electronic device for a vehicle.

### BACKGROUND ART

A vehicle refers to a device that carries a passenger in a direction intended by a passenger. A car is a major example of such a vehicle. In the industrial field of vehicles, application of an advanced driver assistance system (ADAS) is under active study to increase the driving convenience of users. Furthermore, the application of autonomous driving of vehicles is also under active study.

The application of ADAS or the application of autonomous driving may be configured based on map data. Conventionally, low-scale standard definition (SD) map data is provided to users while being stored in a memory installed in a vehicle. However, recently, as the need for high-scale high-definition (HD) map data has increased, map data into which a cloud service is integrated has come to be provided to users.

In order to embody ADAS application or autonomous driving application using an HD map, an HD map received from a server needs to be assumed to match data of an object acquired by an object detection device included in a vehicle. However, there is a method of response to the case in which it is not possible to acquire exact data of an object depending on various situations.

### DISCLOSURE

### Technical Problem

To overcome the aforementioned problems, the present disclosure may provide an electronic device for map matching even in various situations.

The present disclosure may provide a method of operating an electronic device for map matching even in various situations.

It will be appreciated by persons skilled in the art that that the effects that could be achieved with the present disclosure are not limited to what has been particularly described hereinabove and other advantages of the present disclosure will be more clearly understood from the detailed description.

### Technical Solution

In accordance with the present disclosure, the above and other objects can be accomplished by the provision of an electronic device for a vehicle, including a power supply configured to supply power, an interface configured to receive high-definition (HD) map data of a specified region and to receive data of an object from an object detection device, and a processor configured to continuously acquire electronic horizon data of the specified region based on the HD map data in a state in which the power is received, to perform map matching based on the data of the object, and to perform map matching based on a second object set to new map matching feature when map matching based on a first object preset to map matching feature fails.

Details of other embodiments are included in detailed descriptions and drawings.

### Advantageous Effects

As is apparent from the foregoing description, the embodiments of the present disclosure have the following one or more effects.

First, when map matching based on a specific object fails, map matching may also be performed based on another object, and thus autonomous driving may be maintained even in a disadvantageous situation.

Second, autonomous driving may be maintained in a specific situation, and thus the safety of a user may be ensured and user convenience may be maintained.

It will be appreciated by persons skilled in the art that that the effects that could be achieved with the present disclosure are not limited to what has been particularly described hereinabove and other advantages of the present disclosure will be more clearly understood from the following claims.

### DESCRIPTION OF DRAWINGS

FIG. 1 is a diagram showing a vehicle that travels on a road according to an embodiment of the present disclosure.

FIG. 2 is a diagram for explaining a system according to an embodiment of the present disclosure.

FIG. 3A is a control block diagram of a vehicle according to an embodiment of the present disclosure.

FIG. 3B is a control block diagram of an electronic device according to an embodiment of the present disclosure.

FIG. 4 is diagram showing an example of the outer appearance of an electronic device according to an embodiment of the present disclosure.

FIGS. 5A to 5C are flowcharts of a signal inside a vehicle including an electronic device according to an embodiment of the present disclosure.

FIGS. 6A and 6B are diagrams for explaining an operation of receiving high-definition (HD) map data according to an embodiment of the present disclosure.

FIG. 6C is a diagram for explaining an operation of generating electronic horizon data according to an embodiment of the present disclosure.

FIG. 7 is a flowchart of an electronic device according to an embodiment of the present disclosure.

FIGS. 8 to 17 are diagrams for explaining an operation of an electronic device according to an embodiment of the present disclosure.

### BEST MODE

Reference will now be made in detail to exemplary embodiments of the present disclosure, examples of which are illustrated in the accompanying drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purposes of clarity and brevity. The features of the present disclosure will be more clearly understood from the accompanying drawings, and should not be understood to be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, “third” etc. may be used herein to describe various elements, these elements should not be limited by these terms. These terms are only used to distinguish one element from another element.

It will be understood that when an element is referred to as being “on”, “connected to” or “coupled to” another element, it may be directly on, connected to or coupled to the other element, or intervening elements may be present. In contrast, when an element is referred to as being “directly on,” “directly connected to” or “directly coupled to” another element or layer, there are no intervening elements present.

Singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

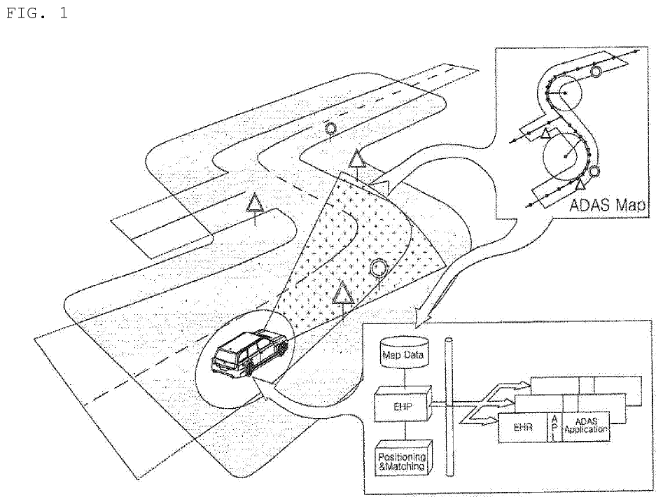

FIG. 1 is a diagram showing a vehicle that travels on a road according to an embodiment of the present disclosure.

Referring to FIG. 1, a vehicle 10 according to an embodiment may be defined as a form of a transport that travels on a road or rails. The vehicle 10 may be interpreted as including an automobile, a train, or a motorcycle. Hereinafter, an autonomous driving vehicle that travels without driver manipulation for driving or a vehicle including an advanced driver assistance system (ADAS) will exemplify the vehicle 10.

The vehicle described in this specification may include a vehicle equipped with an internal combustion engine as a power source, a hybrid vehicle equipped with both an engine and an electric motor as a power source, and an electric vehicle equipped with an electric motor as a power source.

The vehicle 10 may include an electronic device 100. The electronic device 100 may be referred to as an electronic horizon provider (EHP). The electronic device 100 may be conductively connected to another electronic device inside the vehicle 10 in the state of being installed in the vehicle 10.

The vehicle 10 may interact with at least one robot. The robot may be an autonomous mobile robot (AMR) that autonomously travels. The AMR is autonomously moveable and freely moves, and includes a plurality of sensors for avoiding an obstacle or the like while traveling. The AMR may be a flight type robot (e.g., a drone) including a flight device. The AMR may be a wheel type robot that includes at least one wheel and moves via rotation of the wheel. The AMR may be a leg type robot that includes at least one leg and moves using the leg.

A robot may function as a device for providing convenience of a user of the vehicle 10. For example, the robot may move a load on the vehicle 10 to a final destination of a user. For example, the robot may guide a road to a final destination to the user who exits from the vehicle 10. For example, the robot may transfer a user who exits from the vehicle 10 to a final destination.

At least one electronic device included in a vehicle may communicate with a robot through a communication device 220.

At least one electronic device included in a vehicle may provide, to the robot, data processed by at least one electronic device included in the vehicle. For example, the at least one electronic device included in the vehicle may provide, to the robot, at least one of object data, HD map data, vehicle state data, vehicle position data, or driving plan data.

The at least one electronic device included in the vehicle may receive data processed by the robot, from the robot. The at least one electronic device included in the vehicle may receive at least one of sensing data generated by the robot, object data, robot state data, robot position data, or robot moving plan data.

The at least one electronic device included in the vehicle may generate a control signal in further consideration of the data received from the robot. For example, the at least one electronic device included in the vehicle may compare information on an object generated by an object detection device 210 with information on an object generated by a robot and may generate a control signal based on the comparison result. The at least one electronic device included in the vehicle may generate a control signal to prevent interference between a moving route of the vehicle 10 and a moving route of the robot.

The at least one electronic device included in the vehicle may include a software module or a hardware module (hereinafter, an AI module) which implements artificial intelligence (AI). The at least one electronic device included in the vehicle may input the acquired data to the AI module and may use data output from the AI module.

The AI module may perform machine learning on input data using at least one artificial neural network (ANN). The AI module may output the driving plan data by performing machine learning on the input data.

The at least one electronic device included in the vehicle may generate a control signal based on the data output from the AI module.

In some embodiments, the at least one electronic device included in the vehicle may receive data processed by AI from an external device through the communication device 220. The at least one electronic device included in the vehicle may generate a control signal based on the data processed by AI.

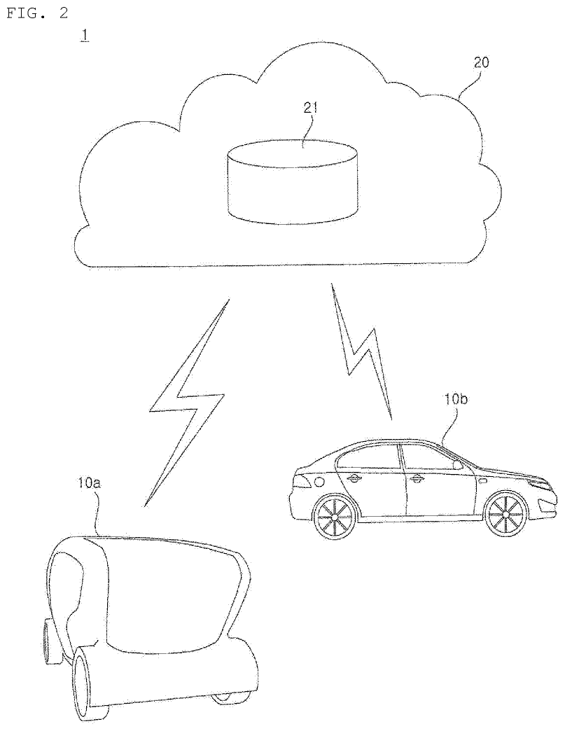

FIG. 2 is a diagram for explaining a system according to an embodiment of the present disclosure.

Referring to FIG. 2, a system 1 may include an infrastructure 20 and at least one vehicle 10a and 10b.

The infrastructure 20 may include at least one server 21. The server 21 may receive data generated by the vehicles 10a and 10b. The server 21 may process the received data. The server 21 may manipulate the received data.

The server 21 may receive data generated by at least one electronic device installed in the vehicles 10a and 10b. For example, the server 21 may receive data generated by at least one of an EHP, a user interface device, an object detection device, a communication device, a driving manipulation device, a main ECU, a vehicle-driving device, a travel system, a sensor, and a position-data-generating-device. The server 21 may generate big data based on the data received from a plurality of vehicles. For example, the server 21 may receive dynamic data from the vehicles 10a and 10b and may generate big data based on the received dynamic data. The server 21 may update HD map data based on the data received from a plurality of vehicles. For example, the server 21 may receive data generated by an object detection device from the EHP included in the vehicles 10a and 10b and may update HD map data.

The server 21 may provide pre-stored data to the vehicles l0a and 10b. For example, the server 21 may provide at least one of high-definition (HD) map data or standard definition (SD) map data to the vehicles 10a and 10b. The server 21 may classify the map data into map data for respective sections, and may provide only the map data corresponding to a section requested by the vehicles 10a and 10b. The HD map data may be referred to as high-precision map data.

The server 21 may provide data that is processed or manipulated by the server 21 to the vehicles 10a and 10b. The vehicles 10a and 10b may generate a travel control signal based on data received from the server 21. For example, the server 21 may provide the HD map data to the vehicles 10a and 10b. For example, the server 21 may provide dynamic data to the vehicles 10a and 10b.

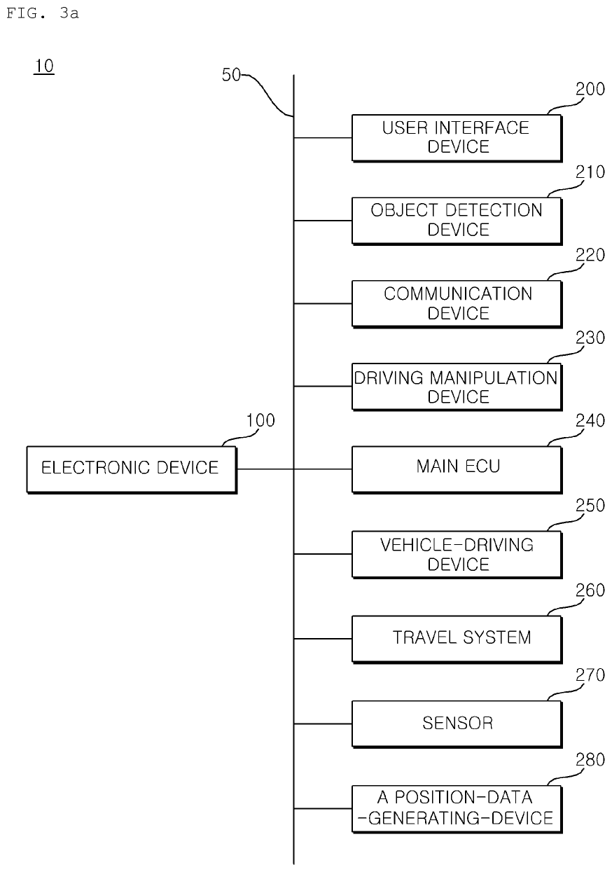

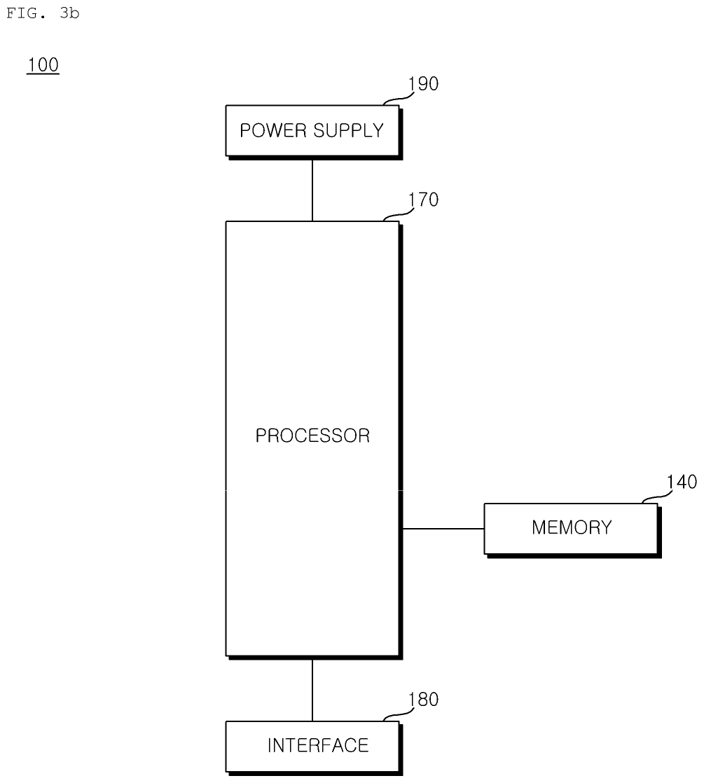

FIG. 3A is a control block diagram of a vehicle according to an embodiment of the present disclosure.

FIG. 3B is a control block diagram of an electronic device according to an embodiment of the present disclosure.

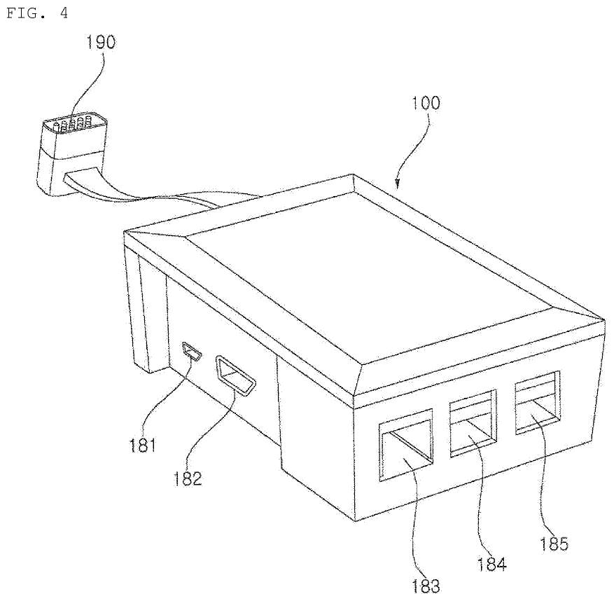

FIG. 4 is diagram showing an example of the outer appearance of an electronic device according to an embodiment of the present disclosure.

Referring to FIGS. 3A to 4, the vehicle 10 may include the electronic device 100, a user interface device 200, an object detection device 210, a communication device 220, a driving manipulation device 230, a main electronic control unit (ECU) 240, a vehicle-driving device 250, a travel system 260, a sensor 270, and a position-data-generating-device 280.

The electronic device 100 may be referred to as an electronic horizon provider (EHP). The electronic device 100 may generate electronic horizon data and may provide the same to at least one electronic device included in the vehicle 10.

The electronic horizon data may be described as driving plan data used to generate a travel control signal of the vehicle 10 in the travel system 260. For example, the electronic horizon data may be understood as driving plan data within a range to a horizon from the point where the vehicle 10 is positioned. Here, the horizon may be understood as a point a preset distance ahead of the point at which the vehicle 10 is positioned based on a preset travel path. The horizon may refer to a point that the vehicle 10 is capable of reaching after a predetermined time from the point at which the vehicle is positioned along the preset traveling path. Here, the travel path may refer to a travel path to a final destination, and may be set by user input.

The electronic horizon data may include horizon map data and horizon path data.

The horizon map data may include at least one of topology data, ADAS data, HD map data, or dynamic data. In some embodiments, the horizon map data may include a plurality of layers. For example, the horizon map data may include a first layer matching the topology data, a second layer matching the ADAS data, a third layer matching the HD map data, and a fourth layer matching the dynamic data. The horizon map data may further include static object data.

The topology data may be described as a map made by connecting middle parts of roads. The topology data may be appropriate to broadly indicate the position of a vehicle and may be configured in the form of data that is mainly used in a navigation device for a driver. The topology data may be understood as data about road information other than information on lanes. The topology data may be generated based on data received from the infrastructure 20. The topology data may be based on data generated by the infrastructure 20. The topology data may be based on data stored in at least one memory included in the vehicle 10.

The ADAS data may refer to data related to information on a road. The ADAS data may include at least one of data on a slope of a road, data on a curvature of a road, or data on a speed limit of a road. The ADAS data may further include data on a no-passing zone. The ADAS data may be based on data generated by the infrastructure 20. The ADAS data may be based on data generated by the object detection device 210. The ADAS data may be referred to as road information data.

The HD map data may include topology information in units of detailed lanes of a road, information on connection between lanes, and information on characteristics for localization of a vehicle (e.g., a traffic sign, lane marking/attributes, or road furniture). The HD map data may be based on data generated by the infrastructure 20.

The dynamic data may include various pieces of dynamic information to be generated on a road. For example, the dynamic data may include information on construction, information on variable-speed lanes, information on the state of a road surface, information on traffic, and information on moving objects. The dynamic data may be based on data received from the infrastructure 20. The dynamic data may be based on data generated by the object detection device 210.

The electronic device 100 may provide map data within a range to a horizon from the point where the vehicle 10 is positioned.

The horizon path data may be described as the trajectory of the vehicle 10 within a range to a horizon from the point where the vehicle 10 is positioned. The horizon path data may include data indicating the relative probability of selection of any one among roads at a decision point (e.g., a forked road, a junction, or an intersection). The relative probability may be calculated based on the time taken to reach a final destination. For example, when a first road is selected at the decision point, if the time taken to reach a final destination is shorter than in the case in which a second road is selected, the probability of selecting the first road may be calculated to be higher than the probability of selecting the second road.

The horizon path data may include a main path and a sub path. The main path may be understood as a trajectory formed by connecting roads having a high probability of being selected. The sub path may branch from at least one decision point on the main path. The sub path may be understood as a trajectory formed by connecting roads having a low probability of being selected from at least one decision point on the main path.

The electronic device 100 may include an interface 180, a power supply 190, a memory 140, and a processor 170.

The interface 180 may exchange a signal with at least one electronic device included in the vehicle 10 in a wired or wireless manner. The interface 180 may exchange a signal with at least one of the user interface device 200, the object detection device 210, the communication device 220, the driving manipulation device 230, the main ECU 240, the vehicle-driving device 250, the travel system 260, the sensor 270, or the position-data-generating-device 280 in a wired or wireless manner. The interface 180 may include at least one of a communication module, a terminal, a pin, a cable, a port, a circuit, an element, or a device. The interface 180 may receive HD map data of a specified region. The interface 180 may receive data about an object from the object detection device 210.

The power supply 190 may supply power to the electronic device 100. The power supply 190 may receive power from a power source (e.g., a battery) included in the vehicle 10 and may provide power to each unit of the electronic device 100. The power supply 190 may operate according to a control signal provided from the main ECU 240. The power supply 190 may be embodied as a switched-mode power supply (SMPS).

The memory 140 is conductively connected to the controller 170. The memory 140 may store default data for a unit, control data for controlling the operation of the unit, and input and output data. The memory 140 may be any of various storage devices in hardware, such as read only memory (ROM), random access memory (RAM), erasable and programmable ROM (EPROM), flash drive, and hard drive. The memory 140 may store various data for the overall operation of the vehicle 100, such as programs for processing or controlling in the controller 170.

The processor 170 may be conductively connected to the interface 180 and the power supply 190 and may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions.

The processor 170 may be driven by power provided from the power supply 190. The processor 170 may continuously generate electronic horizon data in the state in which the power supply 190 supplies power.

The processor 170 may generate electronic horizon data. The processor 170 may generate electronic horizon data. The processor 170 may generate horizon path data.

The processor 170 may generate electronic horizon data by applying a traveling situation of the vehicle 10. For example, the processor 170 may generate the electronic horizon data based on traveling direction data and traveling speed data of the vehicle 10.

The processor 170 may combine the generated electronic horizon data with the pre-generated electronic horizon data. For example, the processor 170 may connect horizon map data generated at a first time with horizon map data generated at a second time in terms of position. For example, the processor 170 may connect horizon path data generated at a first time with horizon path data generated at a second time in terms of position.

The processor 170 may provide electronic horizon data. The processor 170 may provide the electronic horizon data to at least one of the travel system 260 or the main ECU 240 through the interface 180.

The processor 170 may include an HD map processor, a dynamic data processor, a matcher, and a path generator.

The HD map processor may receive HD map data from the server 21 through the communication device 220. The HD map processor may store the HD map data. In some embodiments, the HD map processor may process and manipulate the HD map data.

The dynamic data processor may receive dynamic data from the object detection device 210. The dynamic data processor may receive the dynamic data from the server 21. The dynamic data processor may store the dynamic data. In some embodiments, the dynamic data processor may process and manipulate the dynamic data.

The matcher may receive an HD map from the HD map processor. The matcher may receive the dynamic data from the dynamic data processor. The matcher may generate horizon map data by matching the HD map data and the dynamic data.

In some embodiments, the matcher may receive topology data. The matcher may receive ADAS data. The matcher may generate horizon map data by matching topology data, ADAS data, HD map data, and dynamic data.

The path generator may generate horizon path data. The path generator may include a main path generator and a sub path generator. The main path generator may generate main path data. The sub path generator may generate sub path data.

The processor 170 may perform map matching based on data of an object. The map matching may be performed by the matcher. The processor 170 may receive information on map matching feature related on an object set to the map matching feature, from the server 21. The information on the map matching feature may include at least one of information on the position of the object, information on the type of the object, or information on the shape of the object. The processor 170 may receive information on the object set to the map matching feature from the object detection device 210 through the interface 180. The information on the object received from the object detection device 210 may include at least one of the information on the position of the object, the information on the type of the object, or the information on the shape of the object, which is generated by a sensor included in the object detection device 210.

The processor 170 may perform an operation based on a first object preset to the map matching feature. The first object may include a first traffic sign. The first traffic sign may include at least one of a traffic light, a signpost, a traffic sign board, or a traffic sign indicated on a road surface. The processor 170 may acquire first information on map matching feature related to the first traffic sign. For example, the processor 170 may acquire the first information from electronic horizon data. The processor 170 may receive second information related to the first traffic sign from the object detection device 210. The second information may be generated based on data of at least one sensor (e.g., a camera, a RADAR, a LiDAR, and an infrared sensor) included in the object detection device 210. The processor 170 may perform map matching by comparing the first information and the second information. For example, the processor 170 may perform map matching by comparing position information of the second traffic sign in the first information with position information of the second traffic sign in the second information.

When map matching based on the first object preset to the map matching feature fails, the processor 170 may perform map matching based on a second object set to new map matching feature. Whether map matching based on the first object fails may be determined by at least one of the processor 170, the server 21, or another vehicle.

The second object may include a second traffic sign. The second traffic sign may include at least one of a traffic light, a signpost, a traffic sign board, or a traffic sign indicated on a road surface. When map matching of comparing the first information and the second information fails, the processor 170 may receive third information on map matching feature related to the second traffic sign. For example, the processor 170 may receive third information received through the communication device 220 through the interface 180. The processor 170 may receive fourth information on the second traffic sign from the communication device 220. The fourth information may be generated based on data of at least one sensor (e.g., a camera, a RADAR, a LiDAR, and an infrared sensor) included in the object detection device 210. The processor 170 may perform map matching by comparing the third information and the fourth information. For example, the processor 170 may perform map matching by comparing position information of the second traffic sign in the third information and with position information of the second traffic sign in the fourth information.

The second object may include at least one stationary object. The stationary object may include at least one of a street lamp, a street tree, a previously parked vehicle, a pedestrian who waits for the traffic light to change, a signboard, a building, or a guard rail. When map matching of comparing the first information and the second information fails, the processor 170 may receive third information on map matching feature related to the stationary object. For example, the processor 170 may receive the third information received through the communication device 220, through the interface 180. The processor 170 may receive fourth information on the stationary object from the communication device 220. The fourth information may be generated based on data of at least one sensor (e.g., a camera, a RADAR, a LiDAR, and an infrared sensor) included in the object detection device 210. The processor 170 may receive the fourth information on the stationary object sensed by at least one of the LiDAR or the RADAR from an object detection device. The processor 170 may perform map matching by comparing the third information and the fourth information.

The stationary object may include a guard rail. The processor 170 may receive fourth information on a plurality of cloud points towards the guard rail, from the object detection device 210. The plurality of cloud points may be generated by at least one of the LiDAR or the RADAR.

The processor 170 may divide a space around the vehicle 10 into a plurality of regions. When map matching based on the first object positioned in a first region fails, the processor 170 may perform map matching based on a second object positioned in the first region. For example, when map matching based on the first object positioned in a front region of a left side of the vehicle 10 fails, the processor 170 may perform map matching based on the second object positioned in the front region of the left side of the vehicle 10. The second object may include at least one moving object.

The moving object may include at least one of another vehicle or a pedestrian. For example, the second object may include at least one of other vehicles included in a group when the vehicle 10 travels while configuring the group.

The processor 170 may set the second object to a new map matching feature. In this case, the processor 170 may provide information on the second object received from the object detection device 210 to the server 21 through the communication device 220.

The electronic device 100 may include at least one printed circuit board (PCB). The interface 180, the power supply 190, and the processor 170 may be conductively connected to the PCB.

In some embodiments, the electronic device 100 may be integrated into the communication device 220. In this case, the vehicle 10 may include the communication device 220 as a lower-ranking component of the electronic device 100.

The user interface device 200 may be a device for communication between the vehicle 10 and a user. The user interface device 200 may receive user input and may provide information generated by the vehicle 10 to a user. The vehicle 10 may embody a user interface (UI) or user experience (UX) through the user interface device 200.

The object detection device 210 may detect an object outside the vehicle 10. The object detection device 210 may include at least one of a camera, a RADAR, a LiDAR, an ultrasonic sensor, or an infrared sensor. The object detection device 210 may provide data on an object, generated based on a sensing signal generated by a sensor, to at least one electronic device included in a vehicle.

The object detection device 210 may generate dynamic data based on a sensing signal for sensing an object. The object detection device 210 may provide the dynamic data to the electronic device 100.

The object detection device 210 may receive electronic horizon data. The object detection device 210 may include an electronic horizon re-constructor (EHR) 265. The EHR 265 may convert the electronic horizon data into the data format to be used in the object detection device 210.

The camera may generate information on an object outside the vehicle 10 using an image. The camera may include at least one lens, at least one image sensor, and at least one processor that is conductively connected to the image sensor to process a received signal and generates data of an object based on the processed sig.

The camera may be at least one of a mono camera, a stereo camera, or an around view monitoring (AVM) camera. The camera may acquire information about the location of an object, information about a distance to the object, or information about a relative speed with respect to the object by any of various image processing algorithms. For example, the camera may acquire information about a distance to an object and information about a relative speed with respect to the object in an acquired image, based on a variation in the size of the object over time. For example, the camera may acquire information about a distance to an object and information about a relative speed with respect to the object through a pin hole model, road surface profiling, or the like. For example, the camera may acquire information about a distance to an object and information about a relative speed with respect to the object based on disparity information in a stereo image acquired by a stereo camera.

To acquire an image of the exterior of the vehicle, the camera may be installed to ensure a field of view (FOV) in the vehicle. To acquire an image of the front view of the vehicle, the camera may be disposed in the vicinity of a front windshield inside the vehicle. Alternatively, the camera may be disposed around a front bumper or a radiator grille. To acquire an image of what lies behind the vehicle, the camera may be disposed in the vicinity of a rear glass inside the vehicle. Alternatively, the camera may be disposed around a rear bumper, a trunk, or a tail gate. To acquire an image of what lies on a side of the vehicle, the camera may be disposed in the vicinity of at least one of side windows inside the vehicle. Alternatively, the camera may be disposed around a side view mirror, a fender, or a door.

The RADAR may generate information an object outside the vehicle 10 using an electromagnetic wave. The RADAR may include an electromagnetic wave transmitter, an electromagnetic wave receiver, and at least one processor that is conductively connected to the electromagnetic wave transmitter and the electromagnetic wave receiver, and is configured to process a received signal and to generate data of an object based on the processed signal. The RADAR may be implemented by pulse RADAR or continuous wave RADAR according to a radio wave emission principle. The RADAR may be implemented by Frequency Modulated Continuous Wave (FMCW) or Frequency Shift Keying (FSK) according to a signal waveform among the continuous wave radar methods. The RADAR may detect an object in a time of flight (TOF) or phase shifting by electromagnetic waves, and may detect the location, distance, and relative speed of the detected object. The RADAR may be disposed at an appropriate position outside a vehicle in order to detect an object positioned before, behind, or next to the vehicle.

The LiDAR may generate information on an object outside the vehicle 10 using a laser beam. The LiDAR may include an optical transmitter, an optical receiver, and at least one processor that is conductively connected to the optical transmitter and the optical receiver to process a received signal and generates data of an object based on the processed signal. The LiDAR may be implemented using a time of flight (TOF) method or a phase-shift method. The LiDAR may be implemented in a driven or non-driven manner. If the LiDAR is implemented in the driven manner, the LiDAR may be rotated by a motor and detect an object around the vehicle. If the LiDAR is implemented in a non-driven manner, the LiDAR may detect an object within a predetermined range from the vehicle by optical steering. The vehicle 100 may include a plurality of non-driven LiDARs. The LiDAR may detect an object in TOF or phase shifting by laser light, and determine the location, distance, and relative speed of the detected object. The LiDAR may be disposed at an appropriate position outside a vehicle in order to detect an object positioned before, behind, or next to the vehicle.

The communication device 220 may exchange a signal with a device positioned outside the vehicle 10. The communication device 220 may exchange a signal with at least one of an infrastructure (e.g., a server) or other vehicles. The communication device 220 may include at least one of a transmission antenna and a reception antenna for communication, and a radio frequency (RF) circuit or an RF device for embodying various communication protocols.

The communication device 220 may communicate with a device positioned outside the vehicle 10 using a 5G (e.g., new radio (NR)) communication system. The communication device 220 may implement V2X (V2V, V2D, V2P, and V2N) communication using a 5G method.

The driving manipulation device 230 may be a device for receiving user input for driving. In the case of a manual mode, the vehicle 10 may be driven based on a signal provided by the driving manipulation device 230. The driving manipulation device 230 may include a steering input device (e.g., a steering wheel), an acceleration input device (e.g., an accelerator pedal), and a brake input device (e.g., a brake pedal).

The main ECU 240 may control the overall operation of at least one electronic device included in the vehicle 10.

The main ECU 240 may receive electronic horizon data. The main ECU 240 may include an electronic horizon re-constructor (EHR) 265. The EHR 265 may convert the electronic horizon data into a data format to be used in the main ECU 240.

The vehicle-driving device 250 may be a device for electrical control of various devices in the vehicle 10. The vehicle-driving device 250 may include a powertrain driver, a chassis driver, a door/window driver, a safety device driver, a lamp driver, and a conditioning driver. The powertrain driver may include a power source driver and a transmission driver. The chassis driver may include a steering driver, a brake driver, and a suspension driver.

The travel system 260 may perform a traveling operation of the vehicle 10. The travel system 260 may provide a control signal to at least one of a powertrain driver or a chassis driver of the vehicle-driving device 250, and may move the vehicle 10.

The travel system 260 may receive electronic horizon data. The travel system 260 may include an electronic horizon re-constructor (EHR) 265. The EHR 265 may convert the electronic horizon data into a data format to be used in an ADAS application and an autonomous driving application.

The travel system 260 may include at least one of an ADAS application or an autonomous driving application. The travel system 260 may generate a travel control signal using at least one of the ADAS application and the autonomous driving application.

The sensor 270 may sense the state of a vehicle. The sensor 270 may include at least one of an inertial navigation unit (IMU) sensor, a collision sensor, a wheel sensor, a speed sensor, an inclination sensor, a weight detection sensor, a heading sensor, a position module, a vehicle forward/backward sensor, a battery sensor, a fuel sensor, a tire sensor, a steering sensor using rotation of a steering wheel, a vehicle interior temperature sensor, a vehicle interior humidity sensor, an ultrasonic sensor, an illumination sensor, an accelerator pedal position sensor, or a brake pedal position sensor. The inertial navigation unit (IMU) sensor may include one or more of an acceleration sensor, a gyro sensor, and a magnetic sensor.

The sensor 270 may generate data on the state of the vehicle based on a signal generated by at least one sensor. The sensor 270 may acquire a sensing signal for sensing vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward information, battery information, fuel information, tire information, vehicle lamp information, vehicle interior temperature information, vehicle interior humidity information, steering wheel rotation angle, vehicle external illumination, the pressure applied to an accelerator pedal, the pressure applied to a brake pedal, and the like.

In addition, the sensor 270 may further include an accelerator pedal sensor, a pressure sensor, an engine rotation speed sensor, an air flow sensor (AFS), an air temperature sensor (ATS), a water temperature sensor (WTS), a throttle position sensor (TPS), a TDC sensor, and a crank angle sensor (CAS).

The sensor 270 may generate vehicle state information based on sensing data. The vehicle state information may be information generated based on data detected by various sensors included in a vehicle.

For example, the vehicle state information may include vehicle posture information, vehicle speed information, vehicle inclination information, vehicle weight information, vehicle direction information, vehicle battery information, vehicle fuel information, vehicle tire air-pressure information, vehicle steering information, vehicle interior temperature information, vehicle interior humidity information, pedal position information, and vehicle engine temperature information.

The position-data-generating-device 280 may generate position data of the vehicle 10. The position-data-generating-device 280 may include at least one of a global positioning system (GPS) or a differential global positioning system (DGPS). The position-data-generating-device 280 may generate position data of the vehicle 10 based on a signal generated by at least one of the GPS or the DGPS. In some embodiments, the position-data-generating-device 280 may correct the position data based on at least one of an inertial measurement unit (IMU) of the sensor 270 or a camera of the object detection device 210.

The vehicle 10 may include an internal communication system 50. A plurality of electronic devices included in the vehicle 10 may exchange a signal using the internal communication system 50 as a medium. The signal may include data. The internal communication system 50 may use at least one communication protocol (e.g., CAN, LIN, FlexRay, MOST, or Ethernet).

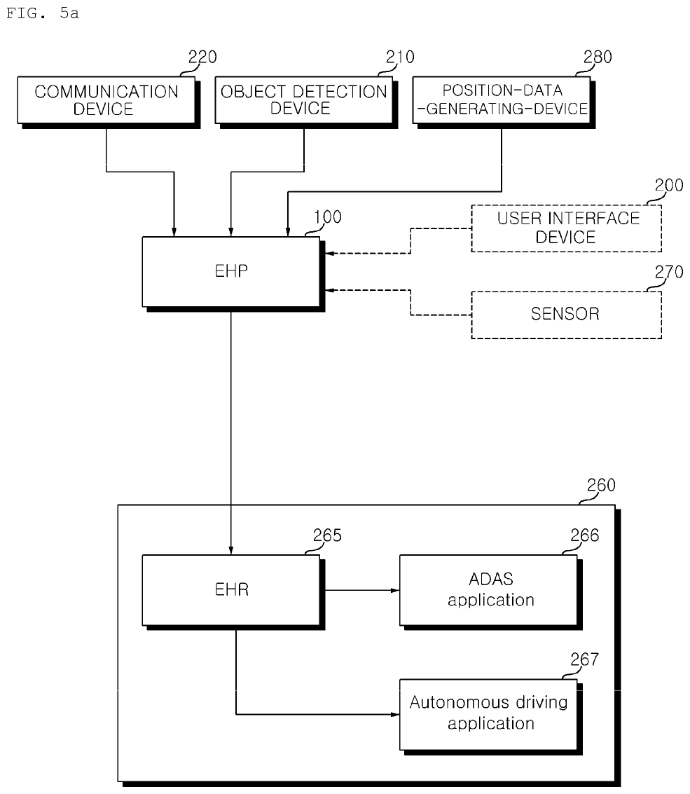

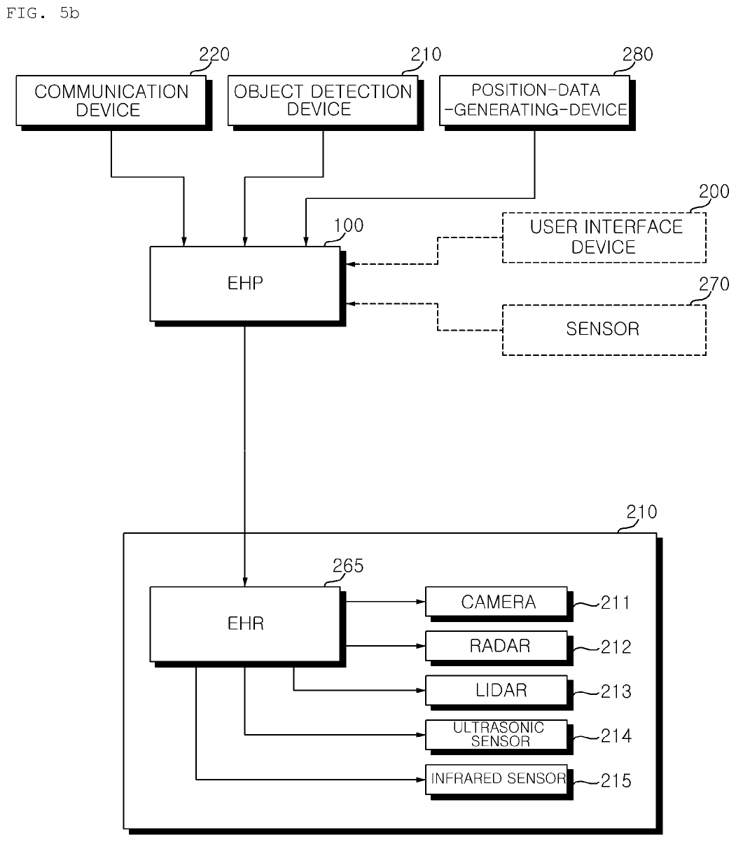

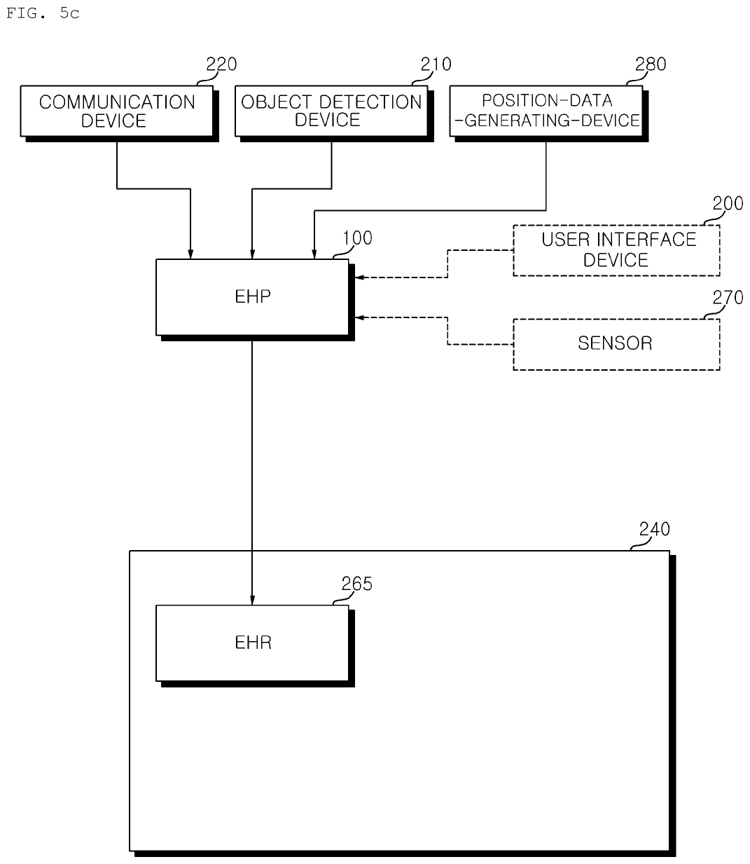

FIG. 5A is a flowchart of a signal inside a vehicle including an electronic device according to an embodiment of the present disclosure.

Referring to FIG. 5A, the electronic device 100 may receive HD map data from the server 21 through the communication device 220.

The electronic device 100 may receive dynamic data from the object detection device 210. In some embodiments, the electronic device 100 may also receive dynamic data from the server 21 through the communication device 220.

The electronic device 100 may receive position data of a vehicle from the position-data-generating-device 280.

In some embodiments, the electronic device 100 may receive a signal based on user input through the user interface device 200. In some embodiments, the electronic device 100 may receive vehicle state information from the sensor 270.

The electronic device 100 may generate electronic horizon data based on HD map data, dynamic data, and position data. The electronic device 100 may match the HD map data, the dynamic data, and the position data with each other to generate horizon map data. The electronic device 100 may generate horizon path data on a horizon map. The electronic device 100 may generate main path data and sub path data on the horizon map.

The electronic device 100 may provide electronic horizon data to the travel system 260. The EHR 265 of the travel system 260 may convert the electronic horizon data into a data format appropriate for applications 266 and 267. The applications 266 and 267 may generate a travel control signal based on the electronic horizon data. The travel system 260 may provide the travel control signal to the vehicle-driving device 250.

The travel system 260 may include at least one of an ADAS application 266 or an autonomous driving application 267. The ADAS application 266 may generate a control signal for assisting the driver in driving of the vehicle 10 through the driving manipulation device 230 based on the electronic horizon data. The autonomous driving application 267 may generate a control signal for moving the vehicle 10 based on the electronic horizon data.

FIG. 5B is a flowchart of a signal inside a vehicle including an electronic device according to an embodiment of the present disclosure.

With reference to FIG. 5B, the embodiment of the present disclosure will be described in terms of differences from FIG. 5A. The electronic device 100 may provide the electronic horizon data to the object detection device 210. The EHR 265 of the object detection device 210 may convert the electronic horizon data into a data format appropriate for the object detection device 210. The object detection device 210 may include at least one of a camera 211, a RADAR 212, a LiDAR 213, an ultrasonic sensor 214, or an infrared sensor 215. The electronic horizon data, the data format of which is converted by the EHR 265, may be provided to at least one of the camera 211, the RADAR 212, the LiDAR 213, the ultrasonic sensor 214, or the infrared sensor 215. At least one of the camera 211, the RADAR 212, the LiDAR 213, the ultrasonic sensor 214, or the infrared sensor 215 may generate data based on the electronic horizon data.

FIG. 5C is a flowchart of a signal inside a vehicle including an electronic device according to an embodiment of the present disclosure.

With reference to FIG. 5C, the embodiment of the present disclosure will be described in terms of differences from FIG. 5A. The electronic device 100 may provide electronic horizon data to the main ECU 240. The EHR 265 of the main ECU 240 may convert the electronic horizon data into a data format appropriate for the main ECU 240. The main ECU 240 may generate a control signal based on the electronic horizon data. For example, the main ECU 240 may generate a control signal for controlling at least one of the user interface device 180, the object detection device 210, the communication device 220, the driving manipulation device 230, the vehicle-driving device 250, the travel system 260, the sensor 270, or the position-data-generating-device 280 based on the electronic horizon data.

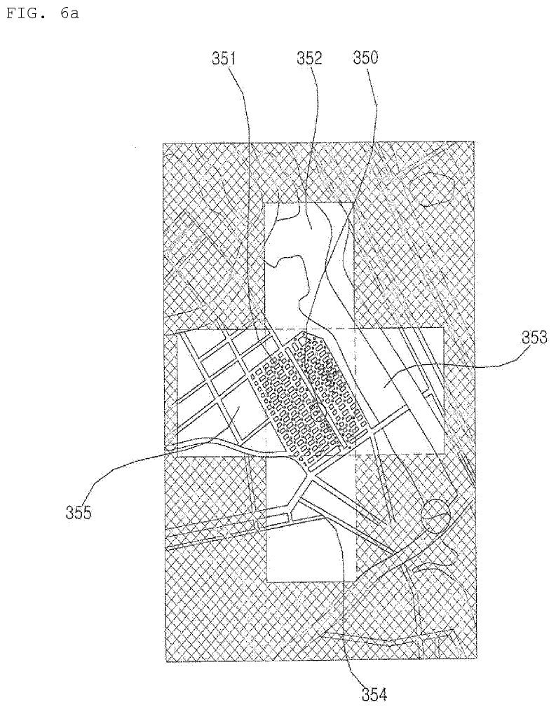

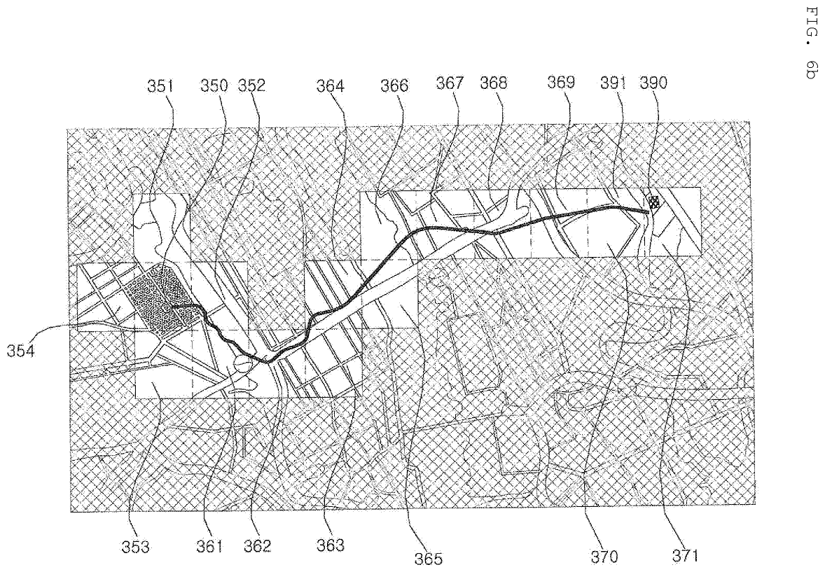

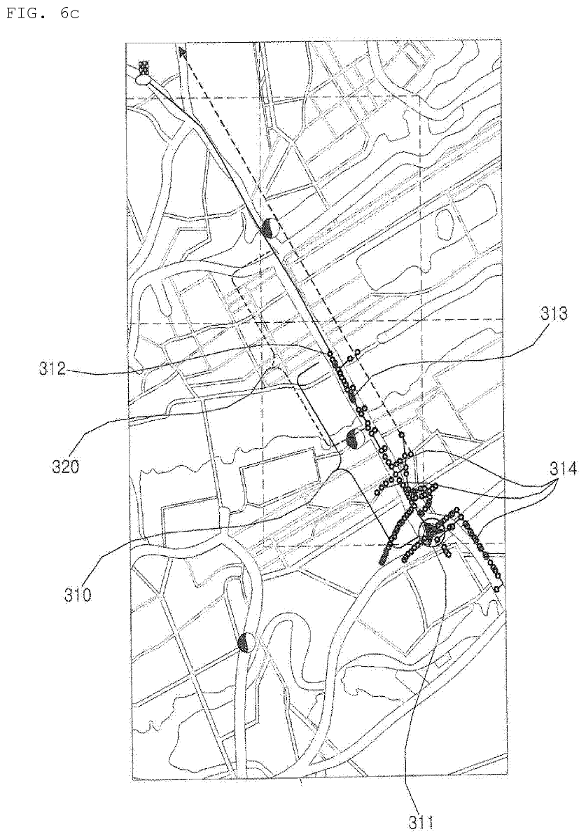

FIGS. 6A and 6B are diagrams for explaining an operation of receiving HD map data according to an embodiment of the present disclosure.

The server 21 may divide the HD map data in units of HD map tiles and may provide the divided HD map data to the electronic device 100. The processor 170 may download the HD map data in units of HD map tiles from the server 21 through the communication device 220.

An HD map tile may be defined as sub HD map data obtained by geographically dividing an entire HD map into rectangular shapes. All HD map data may be acquired by connecting all HD map tiles. The HD map data is high-scale data, and thus the vehicle 10 requires a high-performance controller to download all of the HD map data and to use the downloaded HD map data by the vehicle 10. As communication technologies have been developed, the vehicle 10 may download and use the HD map data in the form of HD map tiles and may thus obviate a high-performance controller rather than requiring inclusion of the high-performance controller, and thus may effectively process data.

The processor 170 may store the downloaded HD map tile in the memory 140. The processor 170 may delete the stored HD map tile. For example, the processor 170 may delete the HD map tile when the vehicle 10 moves out of a section corresponding to the HD map tile. For example, the processor 170 may delete the HD map tile when a preset time elapses since the HD map tile was stored.

FIG. 6A is a diagram for explaining an operation of receiving HD map data when there is no preset destination.

Referring to FIG. 6A, when there is no preset destination, the processor 170 may receive a first HD map tile 351 including a position 350 of the vehicle 10. The server 21 may receive data on the position 350 of the vehicle 10 from the vehicle 10 and may provide the first HD map tile 351 including a position 250 of the vehicle 10 to the vehicle 10. The processor 170 may receive HD map tiles 352, 353, 354, and 355 around the first HD map tile 351. For example, the processor 170 may receive the HD map tiles 352, 353, 354, and 355 that neighbor upper, lower, left, and right sides of the first HD map tile 351, respectively. In this case, the processor 170 may receive five HD map tiles in total. For example, the processor 170 may further receive an HD map tile positioned in a diagonal direction from the first HD map tile 351 along with the HD map tiles 352, 353, 354, and 355 that neighbor upper, lower, left, and right sides of the first HD map tile 351, respectively. In this case, the processor 170 may receive nine HD map tiles in total.

FIG. 6B is a diagram for explaining an operation of receiving HD map data when there is a preset destination.

Referring to FIG. 6B, when there is a preset destination, the processor 170 may receive tiles 350, 352, 361, 362, 363, 364, 365, 366, 367, 368, 369, 370, and 371 associated with a path 391 to the position 350 of the vehicle 10. The processor 170 may receive the plurality of tiles 350, 352, 361, 362, 363, 364, 365, 366, 367, 368, 369, 370, and 371 to cover the path 391.

The processor 170 may receive all of the tiles 350, 352, 361, 362, 363, 364, 365, 366, 367, 368, 369, 370, and 371, which cover the path 391, at one time.

While the vehicle 10 moves along the path 391, the processor 170 may separately receive all of the tiles 350, 352, 361, 362, 363, 364, 365, 366, 367, 368, 369, 370, and 371. While the vehicle 10 moves along the path 391, the processor 170 may receive only at least some of the tiles 350, 352, 361, 362, 363, 364, 365, 366, 367, 368, 369, 370, and 371 based on the position of the vehicle 10. Then, the processor 170 may continuously receive tiles and may delete the pre-received tiles while the vehicle 10 moves.

FIG. 6C is a diagram for explaining an operation of generating electronic horizon data according to an embodiment of the present disclosure.

Referring to FIG. 6C, the processor 170 may generate the electronic horizon data based on HD map data. The vehicle 10 may travel in the state in which a final destination is set. The final destination may be set based on user input received through the user interface device 200 or the communication device 220. In some embodiments, the final destination may also be set by the travel system 260.

In the state in which the final destination is set, the vehicle 10 may be positioned within a preset distance from a first point while traveling. When the vehicle 10 is positioned within a preset distance from the first point, the processor 170 may generate electronic horizon data using a first point as a start point and a second point as an end point. Each of the first point and the second point may be one point on a path toward the final destination. The first point may be described as the point at which the vehicle 10 is currently positioned or is to be positioned in the near future. The second point may be described as the aforementioned horizon.

The processor 170 may receive an HD map of a region including a section to the second point from the first point. For example, the processor 170 may make a request for an HD map of a region within a predetermined radius from a section to the second point from the first point and may receive the HD map.

The processor 170 may generate electronic horizon data on a region including the section to the second point from the first point based on the HD map. The processor 170 may generate horizon map data of the region including the section to the second point from the first point. The processor 170 may generate horizon path data of the region including the section to the second point from the first point. The processor 170 may generate data on a main path 313 of the region including the section to the second point from the first point. The processor 170 may generate data on a sub path 314 of the region including the section to the second point from the first point.

When the vehicle 10 is positioned within a preset distance from the second point, the processor 170 may generate electronic horizon data using a second point as a start point and a third point as an end point. Each of the second point and the third point may be one point on a path toward a final destination. The second point may be described as a point at which the vehicle 10 is currently positioned or is to be positioned in the near future. The third point may be described as the aforementioned horizon. The electronic horizon data using the second point as a start point and the third point as an end point may be geographically connected to the aforementioned electronic horizon data using the first point as a start point and the second point as an end point.

The aforementioned operation of generating the electronic horizon data using the first point as a start point and the second point as an end point may be applied in the same way to the operation of generating the electronic horizon data using the second point as a start point and the third point as an end point.

In some embodiments, the vehicle 10 may also travel in the state in which a final destination is not set.

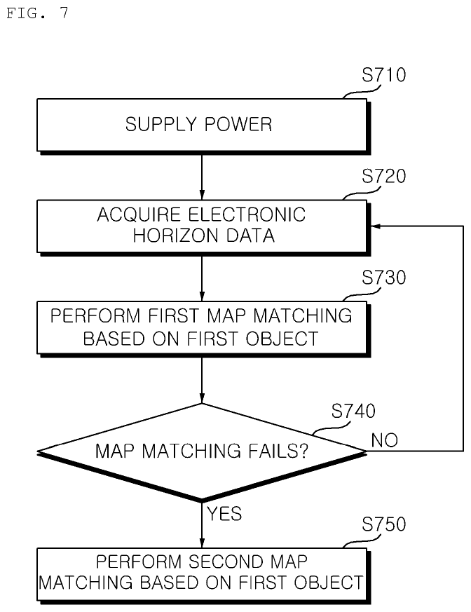

FIG. 7 is a flowchart of an electronic device according to an embodiment of the present disclosure.

Referring to FIG. 7, at least one processor 170 may receive power from the power supply 190 (S710). The at least one processor 170 may continuously acquire electronic horizon data of a specified region based on HD map data in the state in which the power is received (S720).

The at least one processor 170 may perform first map matching based on the first object preset to map matching feature (S730). The first object may include a first traffic sign. The first traffic sign may include at least one of a traffic light, a signpost, a traffic sign board, or a traffic sign indicated on a road surface. Operation S730 of performing the first map matching may include receiving first information on map matching feature related to the first traffic sign by the at least one processor 170, receiving second information related to the first traffic sign from the object detection device 210 by the at least one processor 170, and performing map matching by comparing the first information and the second information by the at least one processor 170.

When map matching based on the first object preset to map matching feature fails (S740), the at least one processor 170 may perform second map matching based on the second object preset to new map matching feature (S750). Whether map matching based on the first object fails may be determined by at least one of the processor 170, the server 21, or another vehicle.

The second object may include a second traffic sign. The second traffic sign may include at least one of a traffic light, a signpost, a traffic sign board, or a traffic sign indicated on a road surface. Operation S750 of performing the second map matching may include receiving third information on map matching feature related to the second traffic sign by the at least one processor 170 when map matching of comparing the first information and the second information fails, receiving fourth information on the second traffic sign from the object detection device 210 by the at least one processor 170, and performing map matching by comparing the third information and the fourth information by the at least one processor 170.

The second object may include at least one stationary object. The stationary object may include at least one of a street lamp, a street tree, a previously parked vehicle, a pedestrian who waits for the traffic light to change, a signboard, a building, or a guard rail. Operation S750 of performing the second map matching may include receiving third information on map matching feature related to the stationary object by the at least one processor 170 when map matching of comparing the first information and the second information fails, receiving fourth information on the stationary object from the object detection device 210 by the at least one processor 170, and performing map matching by comparing the third information and the fourth information by the at least one processor 170.

The operation of receiving the fourth information may include receiving fourth information on the stationary object sensed by at least one of a LiDAR and a RADAR from the object detection device 210 by the at least one processor 170. The stationary object may include a guard rail. The operation of receiving the fourth information may include receiving fourth information on a plurality of cloud points towards the guard rail, from the object detection device 210, by the at least one processor 170. The plurality of cloud points may be generated by at least one of the LiDAR or the RADAR.

The method of operating an electronic device for a vehicle may further include dividing a space around a vehicle into a plurality of regions by the at least one processor 170. The dividing operation may be performed between operations S720 and S730. In this case, the operation of performing the second map matching (S750) may include performing map matching based on the second object positioned in the first region when map matching based on the first object positioned in the first region among a plurality of regions fails.

The second object may include at least one moving object. For example, when the vehicle 10 travels while configuring a group, the second object may include at least one of other vehicles included in the group.

The method of operating an electronic device for a vehicle may further include setting the second object to new map matching feature by at least one processor. The setting operation may be performed between operations S740 and S750.

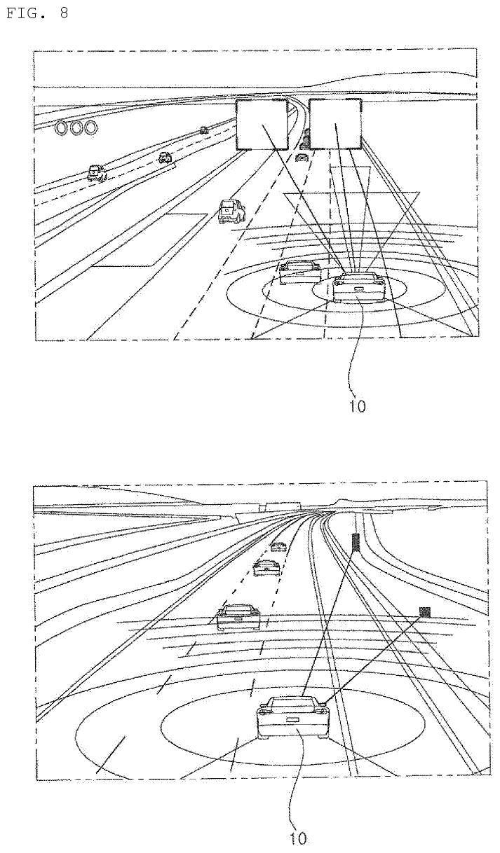

FIGS. 8 to 17 are diagrams for explaining an operation of an electronic device according to an embodiment of the present disclosure. The operation of the electronic device for a vehicle of FIGS. 8 to 17 may be performed by the processor 170.

Referring to FIG. 8, in an HD map, data to be used by the vehicle 10 may be referred to as feature or road furniture. The feature may be a traffic sign, sign faces, a barrier, each lane, a lane property, a guide-rail, a pole, or the like, and a map including such features may be referred to as a feature map. Data included in a map based on the feature is made in consideration of a camera, and thus detection of almost all data and a localization algorithm using the same may correspond to sensor fusion of a GNSS, an IMU, and a camera. In this case, data about a detected object may be transmitted to the server 21 through an electronic device inside a vehicle. The server 21 may maintain the up-to-data characteristics of a map through received position information of each object. This method may have a problem in that the up-to-data characteristics of the map are not maintained when a camera is not capable of detecting a corresponding object.

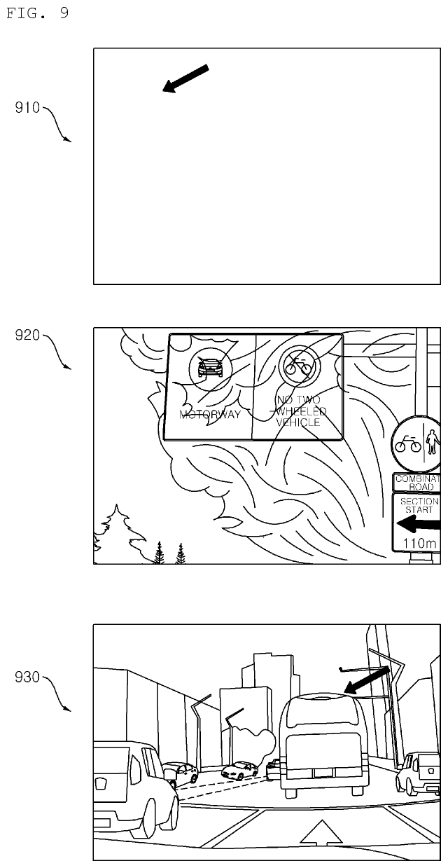

Referring to FIG. 9, as indicated by reference numeral 910, a traffic sign may not be detected by a camera when it is foggy. When the traffic sign is a variable signal, the current state may not be updated to the server 21. As indicated by reference numeral 920, when a traffic sign at a road side is not seen by a stationary obstacle such as a street tree, it may not be possible to detect the traffic sign through the camera. As indicated by reference numeral 930, the traffic sign is hidden by another vehicle (e.g., another vehicle) due to much traffic, it may not be possible to detect the traffic signal through the camera.

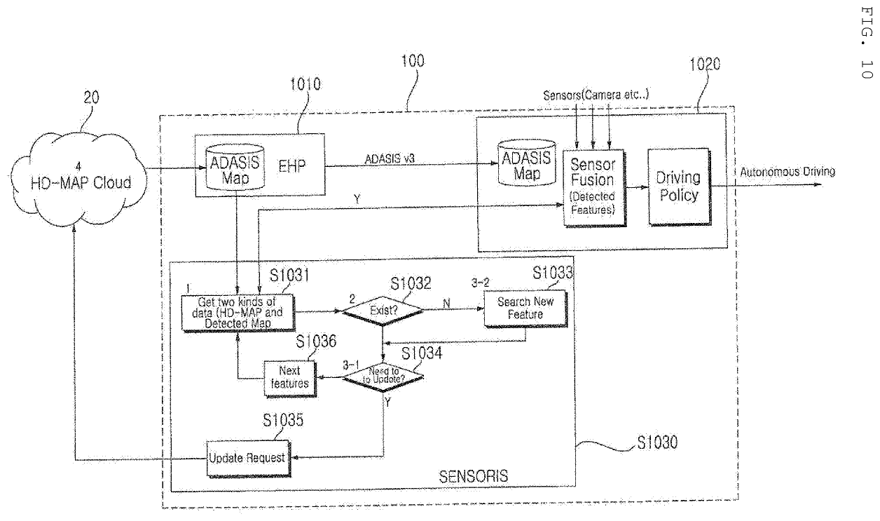

Referring to FIG. 10, the electronic device 100 for a vehicle may include an electronic horizon provider (EHP) 1010, a driving policy provider 1020, and a map matcher 1030. The EHP 1010, the driving policy provider 1020, and the map matcher 1030 may be classified as low-ranking components of the processor 170.

The EHP 1010 may generate and provide electronic horizon data. The driving policy provider 1020 may generate and provide a driving policy based on the electronic horizon data and sensing data received from the object detection device 210. The map matcher 1030 may perform map matching based on an object set to map matching feature.

The map matcher 1030 may acquire information (first information) on an object set to map matching feature from the electronic horizon data (S1031). The map matcher 1030 may receive information (second information) on an object set to map matching feature from the object detection device 210 (S1031). The map matcher 1030 may further receive information on other objects other than the object set to the map matching feature from the object detection device 210.

The map matcher 1030 may perform map matching by comparing the first information and the second information (S1032). The map matcher 1030 may determine whether feature of an HD map is detected by the object detection device 210 by comparing the first information and the second information.

In operation S1032, when determining that the feature of the HD map is detected by an object detection device, the processor 170 may determine whether the HD map needs to be updated (S1034).

When determining that the HD map needs to be updated, the processor 170 may make a request to the infrastructure 20 for the HD map to be updated (S1035). When determining that the HD map does not need to be updated, the processor 170 may prepare for comparison of next map matching feature (S1036).

In operation S1032, when determining that the feature of the HD map is not detected by an object detection device, the processor may select data for extracting a feature point from information on other objects other than the object set to the map matching feature received in operation S1031 and may make a request for the data to be updated (S1033, S1034, and S1035).

When there is an update request for existing HD map data, the server 21 included in the infrastructure 20 may update the existing HD map data according to a predetermined policy. The server 21 may newly register and serve additional data other than the existing HD map data.

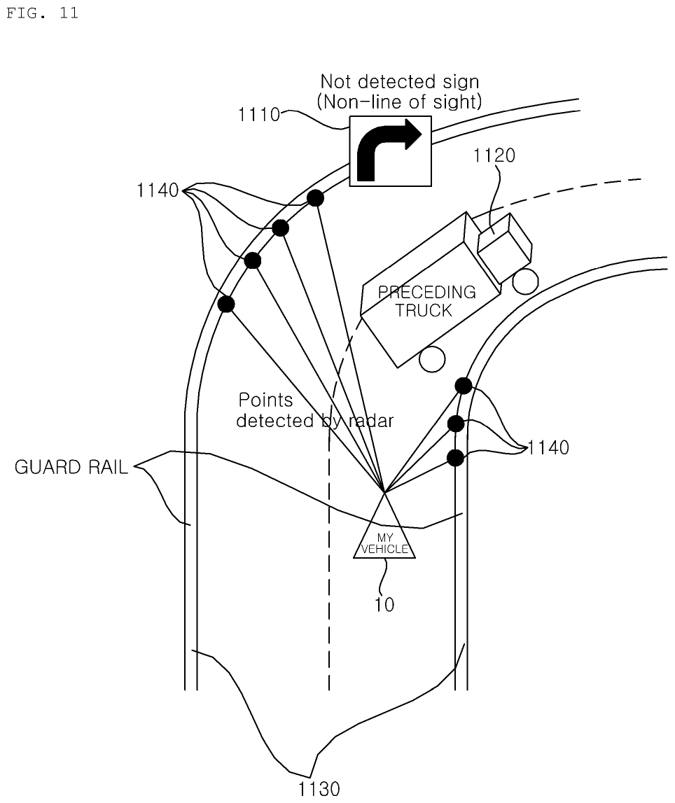

Referring to FIG. 11, a traffic sign 1110 may be hidden by a preceding truck 1120 in a curve section in terms of the vehicle 10. In this case, the traffic sign 1110 may not be detected by the camera of the object detection device 210.

The electronic device 100 for a vehicle may receive an output value (e.g., a cloud point 1140) of at least one of a LiDAR and a RADAR from the object detection device 210. The electronic device 100 for a vehicle may make a request to the infrastructure 20 for the output value to be updated. The electronic device 100 for a vehicle may update the data (e.g., a non-linear mathematical model or an absolute position of the guard rail) of a guide-rail 1130 of the curve section. Through the update, the electronic device 100 for a vehicle may store the updated data in the infrastructure 20 as additional feature for facilitating determination of the position of the vehicle 10 in the situation in which the traffic sign 1110 is hidden.

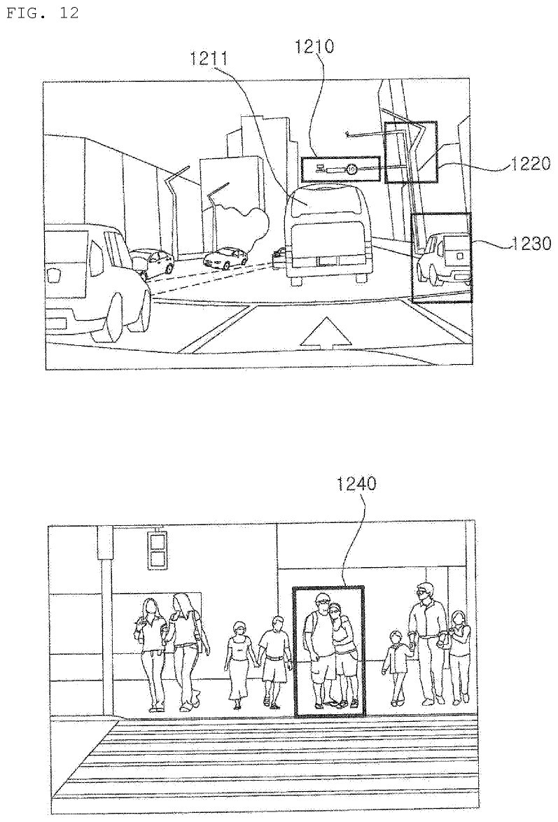

Referring to FIG. 12, a traffic sign 1210 may be hidden by a preceding vehicle 1211 from a viewpoint of the vehicle 10, and thus it may not be possible to detect the traffic sign 1210 by the camera of the object detection device 210. In this case, the electronic device 100 for a vehicle may transmit an image of the state in which it is not possible to detect a traffic sign 1200, to the server 21.

The server 21 may store GPS information of objects to be new map matching feature from other vehicles or pedestrians. For example, when receiving a request for a picture of a utility pole to be a new feature in a corresponding section, the server 21 may recognize and store the GPS information of the utility pole. When simultaneously or periodically receiving requests from a parked vehicle, a cellular phone of people who sit in a café for a long time, or the like, the server 21 may store GPS of corresponding information and may provide the same to a vehicle.

The electronic device 100 for a vehicle may transmit an image of other objects 1220, 1230, and 1240 to the server 21 and may receive GPS information of an object to be new map matching feature from the server 21. The electronic device 100 for a vehicle may register the new map matching feature based on the GPS information received from the server 21. The electronic device 100 for a vehicle may have help for determining the position of the vehicle 10 using the map matching feature.

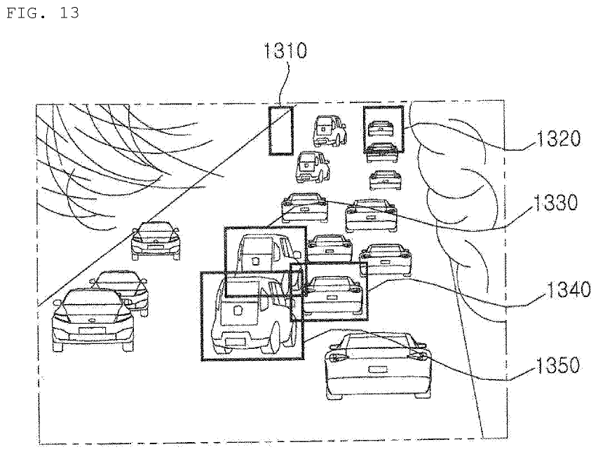

Referring to FIG. 13, when it snows, it is foggy, or it rains, it may be difficult to detect an object by a camera of the object detection device 210. In this case, the electronic device 100 for a vehicle may receive GPS information of other near vehicles. The electronic device 100 for a vehicle may calculate a distance from other near vehicles using sensing data of the RADAR or the LiDAR of the object detection device 210. In this situation, the electronic device 100 for a vehicle needs to pre-acquire related information and needs to complexly use various pieces of information in order to a more extract position. The electronic device 100 for a vehicle may lower a weight of the reliability of information by a camera, may increase a weight of information received through V2V, and may perform map matching. The electronic device 100 for a vehicle may facilitate determination of the position of the vehicle 10 by adjusting a weight of GPS information and RADAR information.

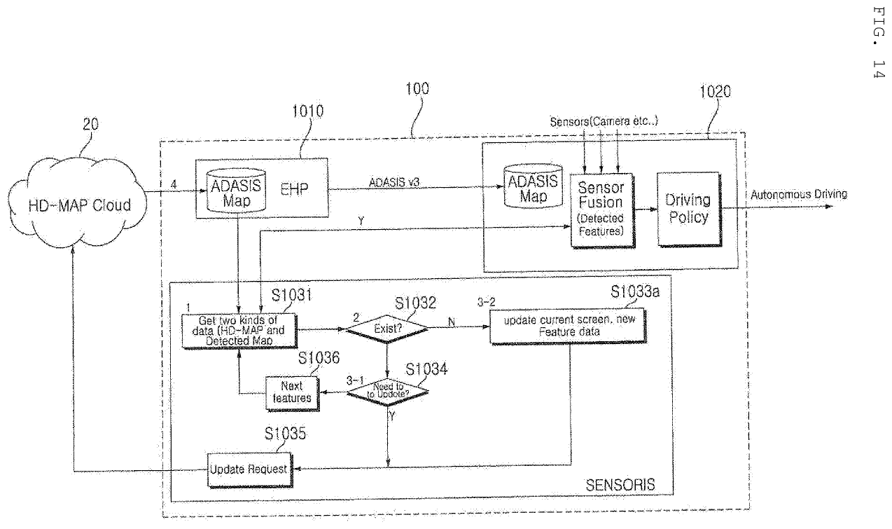

Referring to FIG. 14, operations of the electronic device 100 for a vehicle of FIG. 14 may be the same as those in FIG. 10 except for operation S1033 of the operations of the electronic device 100 for a vehicle of FIG. 10. The operations of FIG. 14 will be described in terms of differences from the operations of FIG. 10, and in operation S1032, when determining that feature of an HD map is not detected by an object detection device, the processor 170 may perform an update (S1033a). The processor 170 may set another object other than an object set to an existing map matching feature to new map matching feature and may transmit information on the object set to the new map matching feature to the infrastructure 20.

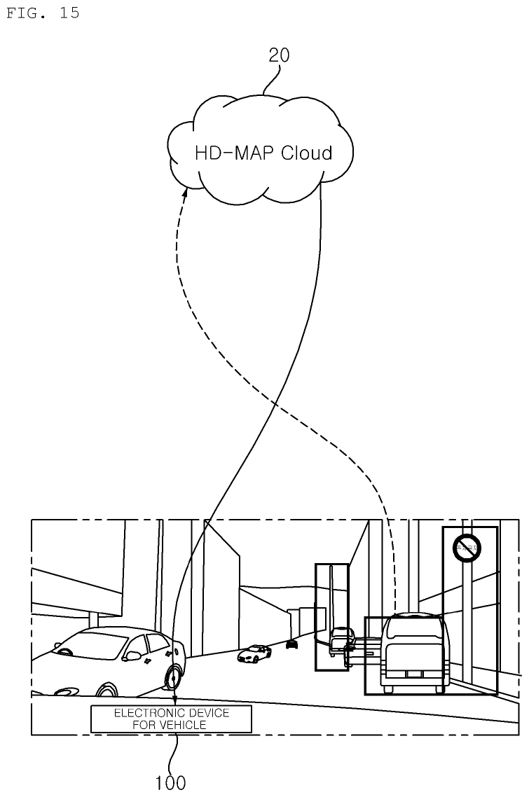

Referring to FIG. 15, the electronic device 100 for a vehicle may transmit an image including an object to be map matching feature to the infrastructure 20. For example, the electronic device 100 for a vehicle may transmit an image including another previously parked vehicle, a utility pole, or the like to the infrastructure 20. The other previously parked vehicle or the utility pole may correspond to an object that is not capable of performing communication but is capable of temporarily receiving information on a stationary GPS. For example, the electronic device 100 for a vehicle may transmit an image including another stationary vehicle, a pedestrian who waits for the traffic light to change at a crosswalk, or the like to the infrastructure 20. Another stationary vehicle or a pedestrian may correspond to an object that is capable of receiving GPS information while being capable of performing communication. A pedestrian may be capable of performing communication using a mobile terminal held by the pedestrian.

The server 21 included in the infrastructure 20 may receive GPS information, feature, and image information of the vehicle 10. The server 21 may provide information on an object set to new map matching feature to the electronic device 100 for a vehicle. For example, the server 21 may provide GPS information of a pedestrian, GPS information of a utility pole, GPS information on another previously parked vehicle, and GPS information of another stationary vehicle to the electronic device 100 for a vehicle.

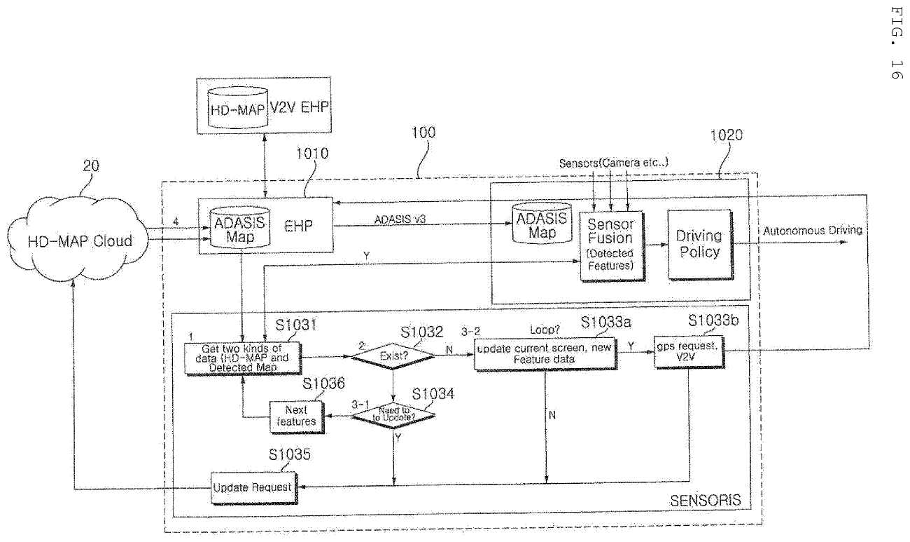

Referring to FIG. 16, operations of the electronic device 100 for a vehicle of FIG. 16 may be the same as those in FIG. 10 except for operation S1033 of the operations of the electronic device 100 for a vehicle of FIG. 10. The operations of FIG. 16 will be described in terms of differences from the operations of FIG. 10, and in operation S1032, when determining that feature of an HD map is not detected by an object detection device, the processor 170 may perform an update (S1033a). The processor 170 may set another object other than an object set to an existing map matching feature to new map matching feature and may transmit information on the object set to the new map matching feature to the infrastructure 20. The electronic device 100 for a vehicle may directly receive GPS information from an object through the communication device 220 (S1033b).

The EHP 1010 may exchange signals with another vehicle through the communication device 220. The EHP 1010 may receive GPS information of the other vehicle. When there is a request for GPS information of the other vehicle from the map matcher 1030, the EHP 1010 may provide GPS information to the other vehicle. The map matcher 1030 may receive GPS information of the other vehicle form the EHP 1010. Here, the other vehicle may be an object (second object) set to the new map matching feature.

In some embodiments, operation S1033b may be performed when operations S1031, S1032, S1033a, S1034, and S1035 are repeatedly performed. GPS information of the other vehicle may be directly received from the other vehicle through V2V communication, and thus delay that occurs during reception of data may be prepared for. The electronic device 100 for a vehicle may lower a weight of a camera, may increase a weight of a RADAR (or LiDAR) or V2V information, and may recognize the position of the vehicle 10.

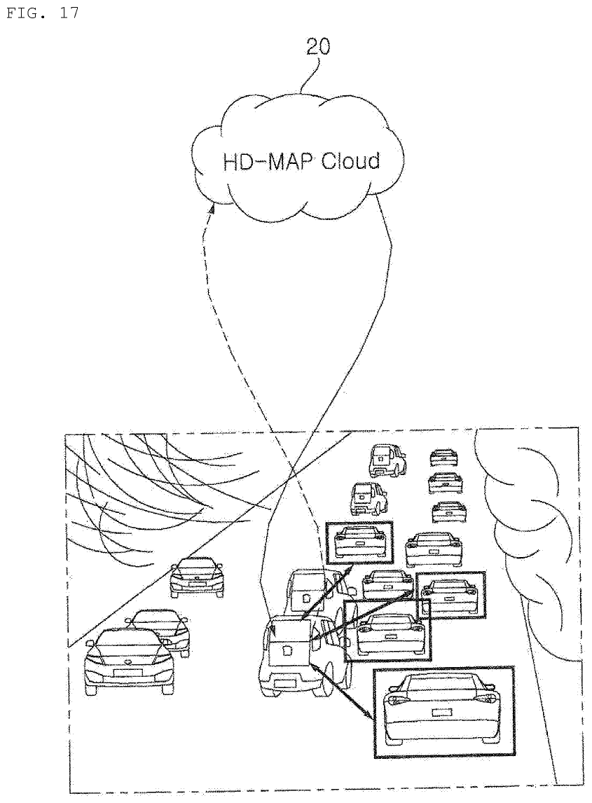

Referring to FIG. 17, when new map matching feature is not registered within a preset time, the electronic device 100 for a vehicle may make a request to the server 21 for GPS information of other near vehicles. The electronic device 100 for a vehicle may receive the GPS information of the other near vehicles from the server 21. The electronic device 100 for a vehicle may receive the GPS information from the other near vehicles. The electronic device 100 for a vehicle may receive information on a distance from another near vehicle sensed by a RADAR or a LiDAR of the object detection device 210. The electronic device 100 for a vehicle may set the other vehicle to the map matching feature based on the received GPS information and the distance information.

The aforementioned present disclosure can also be embodied as computer readable code stored on a computer readable recording medium. The computer readable recording medium is any data storage device that can store data which can thereafter be read by a computer. Examples of the computer readable recording medium include a hard disk drive (HDD), a solid state drive (SSD), a silicon disk drive (SDD), read-only memory (ROM), random-access memory (RAM), CD-ROM, magnetic tapes, floppy disks, optical data storage devices, carrier waves (e.g., transmission via the Internet), etc. The computer may include a processor or a controller. Accordingly, it is intended that the present disclosure cover the modifications and variations of this invention provided they come within the scope of the appended claims and their equivalents.

What is claimed:

1. An electronic device for a vehicle, comprising:
a power supply configured to supply power;
an interface configured to receive high-definition (HD) map data of a specified region and to receive data of an object from an object detection device; and
a processor configured to continuously acquire electronic horizon data of the specified region based on the HD map data in a state in which the power is received, to perform map matching based on the data of the object, and to perform map matching based on a second object set to new map matching feature when map matching based on a first object preset to map matching feature fails.

2. The electronic device of claim 1, wherein whether map matching based on the first object fails is determined by at least one of the processor, a server, or another vehicle.

3. The electronic device of claim 1, wherein the first object comprises a first traffic sign; and
wherein the processor acquires first information on map matching feature related to the first traffic sign from the electronic horizon data, receives second information on the first traffic sign from the object detection device, and performs map matching by comparing the first information and the second information.

4. The electronic device of claim 3, wherein the second object comprises a second traffic sign; and
wherein, when map matching of comparing the first information and the second information fails, the processor receives third information on map matching feature related to the second traffic sign, receives fourth information on the second traffic sign from the object detection device, and performing map matching by comparing the third information and the fourth information.

5. The electronic device of claim 3, wherein the second object comprises at least one stationary object; and
wherein, when map matching of comparing the first information and the second information fails, the processor receives third information on map matching feature related to the stationary object, receives fourth information on the stationary object from the object detection device, and performs map matching by comparing the third information and the fourth information.

6. The electronic device of claim 5, wherein the processor receives the fourth information on the stationary object sensed by at least one of a LiDAR and a RADAR from the object detection device.

7. The electronic device of claim 6, wherein the stationary object comprises a guard rail;
wherein the processor receives the fourth information on a plurality of cloud points toward the guard rail from the object detection device; and
wherein the plurality of cloud points is generated by at least one of the LiDAR or the RADAR.

8. The electronic device of claim 1, wherein the processor divides a space around the vehicle into a plurality of regions, and when map matching based on a first object positioned in a first region of the plurality of regions fails, the processor performs map matching based on a second object positioned in the first region.

9. The electronic device of claim 1, wherein the second object comprises at least one moving object.

10. The electronic device of claim 9, wherein, when the vehicle travels while configuring a group, the second object comprises at least one of other vehicles included in the group.

11. The electronic device of claim 1, wherein the processor sets the second object to new map matching feature, and provides information on the second object received from the object detection device to a server through a communication device.

12. A method of operating an electronic device for a vehicle, the method comprising:
receiving power from a power supply by at least one processor;
continuously acquiring electronic horizon data of a specified region based on high-definition (HD) map data in a state in which the power is received, by the at least one processor;
performing first map matching based on a first object preset to map matching feature by the at least one processor; and
when map matching based on a first object preset to map matching feature fails, performing second map matching based on a second object set to new map matching feature by the at least one processor.

13. The method of claim 12, wherein whether map matching based on the first object fails is determined by at least one of the processor, a server, or another vehicle.

14. The method of claim 12, wherein the first object comprises a first traffic sign; and
wherein the performing the first map matching comprises:
receiving first information on map matching feature related to the first traffic sign from the electronic horizon data by the at least one processor;
receiving second information related to the first traffic sign from the object detection device by the at least one processor; and
performing map matching by comparing the first information and the second information by the at least one processor.

15. The method of claim 14, wherein the second object comprises a second traffic sign; and
wherein the performing the second map matching comprises:
when map matching of comparing the first information and the second information fails, receiving third information on map matching feature related to the second traffic sign by the at least one processor;
receiving fourth information on the second traffic sign from the object detection device by the at least one processor; and
performing map matching by comparing the third information and the fourth information by the at least one processor.

16. The method of claim 14, wherein the second object comprises at least one stationary object; and
wherein the performing the second map matching comprises:
when map matching of comparing the first information and the second information fails, receiving third information on map matching feature related to the stationary object by the at least one processor;
receiving fourth information on the stationary object from the object detection device by the at least one processor; and
performing map matching by comparing the third information and the fourth information by the at least one processor.

17. The method of claim 16, wherein the receiving the fourth information comprises receiving the fourth information on the stationary object sensed by at least one of a LiDAR and a RADAR from the object detection device by the at least one processor.

18. The method of claim 17, wherein the stationary object comprises a guard rail;
wherein the receiving the fourth information comprises receiving the fourth information on a plurality of cloud points toward the guard rail from the object detection device by the at least one processor; and
wherein the plurality of cloud points is generated by at least one of the LiDAR or the RADAR.

19. The method of claim 12, further comprising:
dividing a space around the vehicle into a plurality of regions by the at least one processor,
wherein the performing the second map matching comprises, when map matching based on a first object positioned in a first region of the plurality of regions fails, performing map matching based on a second object positioned in the first region.

20. The method of claim 12, wherein the second object comprises at least one moving object.
